(19) United States
(12) Patent Application Publication
(10) Pub. No.: US 2004/0161163 A1
(43) Pub. Date: Aug. 19, 2004

(54) Portrait image processing method and apparatus

(76) Inventor: Kenya Takamidoh, Asaka-shi (JP)

Correspondence Address: BIRCH STEWART KOLASCH & BIRCH, PO BOX 747, FALLS CHURCH, VA, 22040-0747, US

(21) Appl. No.: 10/776,534

(22) Filed: Feb. 12, 2004

(30) Foreign Application Priority Data
Feb. 14, 2003 (JP) 2003-035949

(51) Int. Cl. G06K 9/40; G06K 9/34

(52) U.S. Cl. 382/275; 382/173

(57) ABSTRACT

A portrait image processing method and a portrait image processing apparatus of the present invention extract a portrait image from an original image and composite the extracted portrait image and a background image prepared in advance to create a composite image. On the other hand, the method and the apparatus detect a boundary of a person and a background from the original image and judges whether or not the detected boundary is a true contour of the person for each part of the boundary. Then, the method and the apparatus apply correction processing (overwrite processing of a correction image) for concealing a boundary part, which is judged not to be the true contour of the person, to the boundary of the person and the background in the composite image. In this way, even in the case in which the portrait image is not extracted accurately from the original image, the method and the apparatus form an image, which is obtained by compositing the extracted portrait image and the background image, as a natural image.

### BACKGROUND OF THE INVENTION

1. Field of the Invention

The present invention relates to a portrait image processing method and a portrait image processing apparatus, and in particular, to a technique for extracting a portrait image from an original image and compositing the extracted portrait image and a background image which is prepared in advance.

2. Description of the Related Art

Conventionally, as a method of extracting a portrait image from an original image, there is known a method of photographing a person with a blue screen as a background (blue back) to acquire an original image and making use of a difference of colors (chroma) to extract a portrait image from the original image and insert the portrait image in another image (chroma key).

In addition, Japanese Patent Application Publication No. 10-13799 discloses a technique for dividing a photographed image into a plurality of blocks arranged as a matrix and sorting the blocks into a background block with small movement and an object block with large movement (block including a portrait image) for each block according to a magnitude of movement among frames.

However, there is a problem in that, although it is easy to extract a portrait image in the case of an original image which is photographed in a simple background such as the blue back, a portrait image cannot be extracted from an original image, which is photographed in an intricate background, satisfactorily.

On the other hand, a method of sorting a portrait image from a background image disclosed in Japanese Patent Application Publication No. 10-13799 has a problem in that, since a magnitude of movement among frames for each block of a photographed image is utilized, the portrait image (a block including a person) and the background image cannot be sorted in the case of a still image or in the case in which the person does not move.

### SUMMARY OF THE INVENTION

The present invention has been achieved in view of such circumstances, and it is an object of the present invention to provide a portrait image processing method and a portrait image processing apparatus which, even in the case in which a portrait image is not extracted accurately from an original image, can form an image, which is obtained by compositing the extracted portrait image and the background image, as a natural image.

In order to attain the above-described object, a portrait image processing method according to a first aspect of the present invention is characterized by comprising the steps of: extracting a portrait image from an original image including a person and a background; compositing the extracted portrait image and a background image prepared in advance to create a composite image; detecting a boundary of the person and the background from the original image; judging whether or not the detected boundary is a true contour of the person for each part of the boundary; and applying correction processing for concealing a boundary part, which is judged not to be a true contour of the person, to the boundary of the person and the background in the created composite image.

Even in the case in which the portrait image is not extracted accurately from the original image (i.e., the boundary of the person and the background detected from the original image does not coincide with the true contour), all parts of the boundary are not necessarily inaccurate but include boundary parts with high certainty as a contour of a person and boundary parts with low certainty as a contour of a person. In the first aspect, in compositing the extracted portrait image and the background image, the image processing for concealing a boundary part is applied to the boundary parts with low certainty as a contour of a person such that a natural composite image is obtained.

In the portrait image processing method of the first aspect, the correction processing may be image processing for overwriting another image on the boundary part which is judged not to be the true contour of the person.

In the portrait image processing method of the first aspect, the correction processing may be image processing for shifting the portrait image such that the boundary part, which is judged not to be the true contour of the person, is outside a frame of ihe composite image.

A portrait image processing apparatus according to a second aspect of the present invention is characterized by comprising: a portrait image extracting device which extracts a portrait image from an original image including a person and a background; a background image recording device which stores a background image to be a background of a portrait image; an image compositing device which composites the extracted portrait image and the background image read out from the background image recording device to create a composite image; a boundary detecting device which detects a boundary of the person and the background from the original image; a judging device which judges whether or not the detected boundary is a true contour of the person for each part of the boundary; and an image correcting device which applies correction processing for concealing a boundary part, which is judged not to be a true contour of the person, to the boundary of the person and the background in the created composite image.

In the portrait image processing apparatus of the second aspect, the image correcting device may perform image processing for overwriting another image on the boundary part which is judged not to be the true contour of the person.

In the portrait image processing apparatus of the second aspect, the image correcting device may perform image processing for shifting the portrait image such that the boundary part, which is judged not to be the true contour of the person, is outside a frame of the composite image.

As described above, according to the present invention, in compositing a portrait image extracted from an original image and an appropriate background image, even in the case in which the original image includes an intricate background image and the portrait image is not extracted accurately from the original image (i.e., a boundary of a person and a background detected from the original image does not coincide with a true contour of the person), since the image processing for concealing a boundary part is applied to the boundary parts with low certainty as a contour of a person, a natural composite image can be obtained.

### BRIEF DESCRIPTION OF THE DRAWINGS

FIG. 1 is a functional block diagram showing a main part of a portrait image processing apparatus in accordance with the present invention;

FIGS. 2A to 2D are diagrams used for explaining an embodiment of a portrait image processing method in accordance with the present invention;

FIG. 3 is a diagram showing boundary parts with high certainty as a contour of a person and boundary parts with low certainty as a contour of a person in a boundary of a person area and a background area of an original image;

FIGS. 4A and 4B are diagrams showing another embodiment of correction processing in the portrait image processing method in accordance with the present invention; and

FIG. 5 is a diagram of a network system to which the portrait image processing method in accordance with the present invention is applied.

### DETAILED DESCRIPTION OF THE PREFERRED EMBODIMENTS

A preferred embodiment of a portrait image processing method and a portrait image processing apparatus in accordance with the present invention will be hereinafter described in detail with reference to the accompanying drawings.

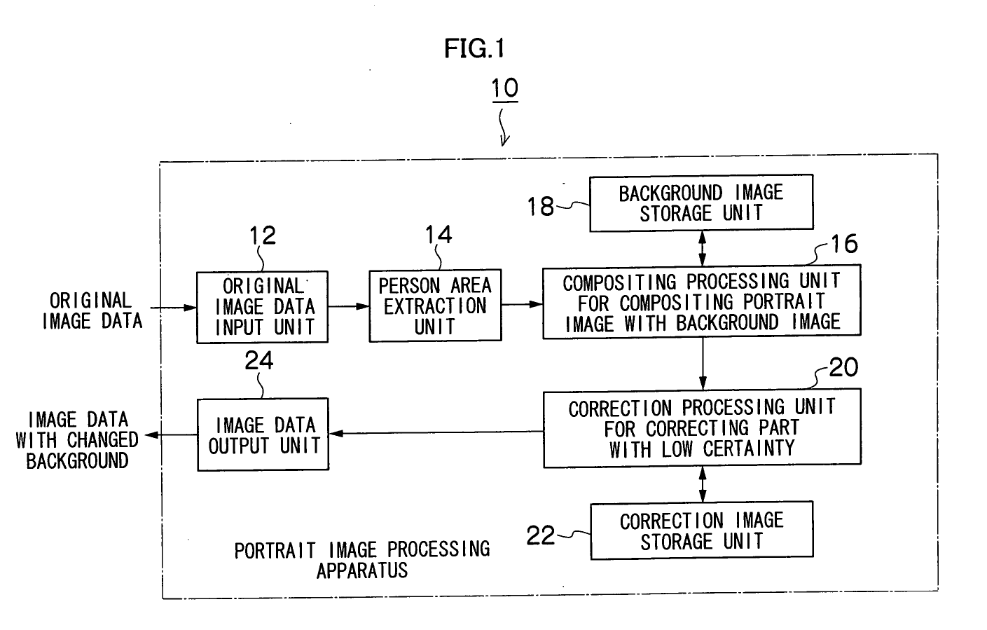

FIG. 1 is a functional block diagram showing a main part of the portrait image processing apparatus in accordance with the present invention.

As shown in the figure, a portrait image processing apparatus 10 can be constituted by a personal computer or the like, and includes an image data input unit 12, a person area extraction unit 14, a compositing processing unit 16, a background image storage unit 18, a correction processing unit 20, a correction image storage unit 22, and an image data output unit 24.

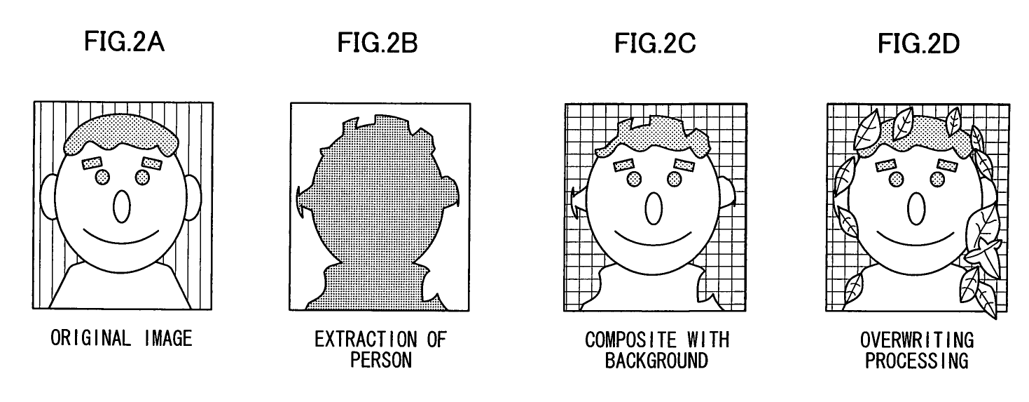

Original image data photographed by a digital still camera (hereinafter referred to as DSC) or the like is inputted to the portrait image processing apparatus 10 via the image data input unit 12. Note that this original image data is portrait image data which is obtained by photographing a person in an arbitrary background as shown in FIG. 2A. As the image data input unit 12, a USB interface, an infrared ray communication (IrDA) interface, an Ethernet interface, and a wireless communication interface may be used other than a media interface for DSC media. A user chooses appropriately, according to a medium in which the original image data is stored or a recording format of the original image data, which interface is applied to the image data input unit 12.

The original image data inputted to the portrait image processing apparatus 10 is outputted to the person area extraction unit 14, where a person area is distinguished from a background area and extracted (see FIG. 2B).

As a method of extracting the person area from the original image, for example, characteristics extracting processing is performed for extracting facial parts such as eyes, a nose, a mouth in the original image. In the characteristics extracting processing, wavelet transformation is performed with respect to the original image to extract and quantize wavelet coefficients of appropriate positions and frequencies. The wavelet coefficients are subjected to matching processing to be matched with facial parts dictionary data which is prepared by performing the same characteristics extracting processing for a large number of sample images in advance, and facial parts are extracted.

A part from which the facial parts are extracted is judged to be a face, to which division processing according to colors and textures is applied. This is processing for collectively dividing areas of similar colors and textures, and for example, a skin color area including coordinates of eyes is set as a face area and an area of black or brown slightly above the coordinates of eyes is set as a hair area to extract a person area. In addition, matching processing for matching person area dictionary data, which indicates an average positional relation between a position of eyes and a boundary of a person and a background, and a boundary of a person area and a background area obtained from the original image is performed to find a boundary of a person area and a background area.

In addition, there are other methods such as a method of applying filter processing for extracting a boundary of a person and a background from a high-frequency component in an original image to extract a person area from the original image, a method of extracting a skin color in an original image, sequentially applying area extension to connected areas, which seem to belong to an identical area, from a certain point of the skin color area, extracting a face area depending upon whether or not an area extracted in this way is a shape of a face, and extracting a hair area above the face area, a neck and chest area below the face area, and the like, to thereby extract a person area. Note that there are various methods are possible as a method of extracting a person area from an original image, which is not limited to the above-described methods.

Image data of the person area extracted by the person area extraction unit 14 is outputted to the compositing processing unit 16. The compositing processing unit 16 composites portrait image data, which is inputted from the person area extraction unit 14, and background image data, which is read out from the background image storage unit 18, and outputs composite image data of the portrait image data and the background image data to the correction processing unit 20.

FIG. 2C shows a composite image obtained by compositing a portrait image with a background image. Note that, as the background image, a desired background image to be composited with the portrait image may be selected out of a plurality of background images stored in the background image storage unit 18 in advance or a background image to be composited with the portrait image may be inputted separately. A method of acquiring the background image is not limited to this embodiment.

First, the correction processing unit 20 determines whether a boundary part is a boundary part with high certainty as a contour of a person or a boundary part with low certainty as a contour of a person from the boundary of the person area and the background area, which are used for the extraction of the person area in the person area extraction unit 14, or a boundary detected from an external circumference of the extracted person area.

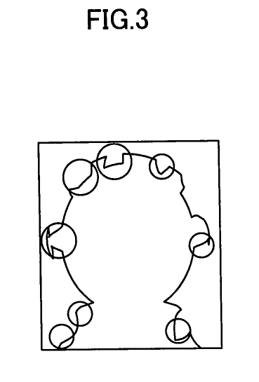

FIG. 3 is a diagram showing boundary parts with high certainty as a contour of a person and boundary parts with low certainty as a contour of a person in a boundary of a person area and a background area. Encircled boundary parts indicate parts which are determined to have low certainty as a contour of a person.

The boundary parts with low certainty correspond to, for example, a boundary part where a length between coordinate points on the boundary is partially larger than a decided value due to unevenness of the boundary, a boundary part which is out of a range of a reference contour line (reference contour line of a person including a head, a neck, shoulders, etc.), which is collected from contours of a large number of people, added with a predetermined margin, or a boundary part which has a shape of each part of the boundary largely different from a shape of the reference contour.

Note that, in the case in which a person is photographed with a screen or the like having a single color and a uniform density as a background, a boundary of the person and the background detected from an original image coincides with a true contour of the person in most cases. However, in the case in which a person is photographed in a background with an intricate pattern or color, a boundary of the person and the background cannot be detected accurately from an original image, and the boundary of the person and the background includes parts which do not coincide with a true contour of the person.

When the boundary part with low certainty as a contour of a person is detected as described above, the correction processing unit 20 performs image processing for concealing the boundary part. In other words, the correction processing unit 20 reads out an appropriate correction image from the correction image storage unit 22 and overwrites this correction image on the boundary part with low certainty as a contour of a person.

FIG. 2D shows a composite image after correction in which the correction image is overwritten on the boundary part with low certainty by the correction processing unit 20. In the embodiment shown in FIG. 2D, an image of leaves is used as a correction image. However, it is preferable to select an appropriate correction image, which does not have a sense of incongruity with respect to the background image, from the correction image storage unit 22. In addition, the overwriting processing may be performed with a hat as a correction image in the case in which the boundary part with low certainty is in the parietal area, or a shawl as a correction image in the case in which the boundary part with low certainty is on the shoulders.

The composite image data corrected by the correction processing unit 20 is outputted as image data, in which the background is composited, via the image data output unit 24. Examples of a form of outputting the image data include a form of outputting the image data to a monitoring device or a printer, and a form of recording the image data in a file format in an external recording medium such as a PC card or a CD-ROM or a hard disk incorporated in the portrait image processing apparatus 10. In addition, a form of transferring the image data to other apparatuses via communication means is also possible. Communication may be performed by wire or by radio.

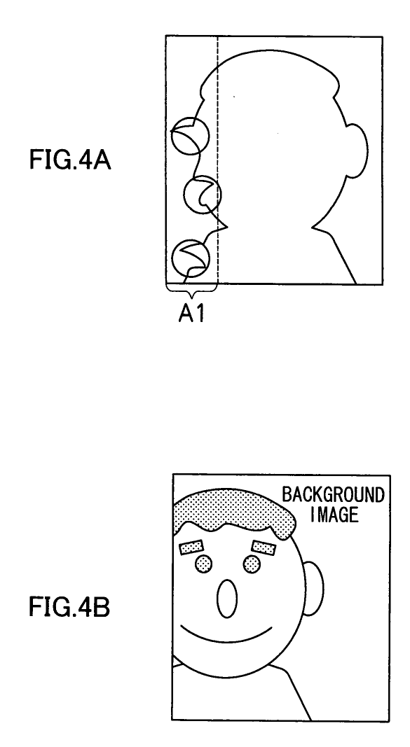

FIGS. 4A and 4B are diagrams showing another embodiment of the correction processing by the correction processing unit 20.

FIG. 4A is a diagram showing boundary parts with high certainty as a contour of a person and boundary parts with low certainty as a contour of a person in a boundary of a person area and a background area. Encircled boundary parts indicate parts which are determined to have low certainty. As shown in the figure, the boundary parts with low certainty concentrate in a left part A of the boundary.

In the case in which the boundary parts with low certainty concentrate only in a part of the boundary of the person area and the background area as shown in FIG. 4A, the correction processing unit 20 shifts a portrait image such that the boundary part with low certainty (left part A1) is out of a composite image.

Note that the correction processing unit 20 may be adapted to perform correction processing which is a combination of the overwriting processing according to the correction image shown in FIG. 2D and the shift of the portrait image shown in FIG. 4B.

The portrait image processing apparatus 10 can be realized by a personal computer. However, the portrait image processing apparatus 10 is not limited to this but may be realized by a service server or the like for image processing on a network.

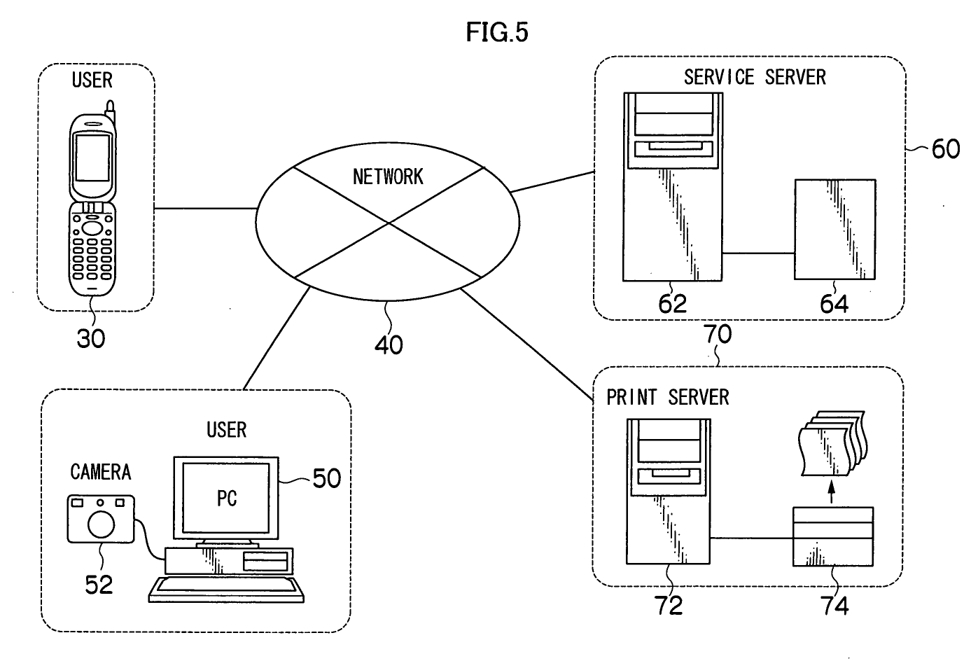

FIG. 5 is a diagram of a network system to which the portrait image processing method in accordance with the present invention is applied.

In FIG. 5, reference numeral 30 designates a cellular phone with camera which is connectable to a network 40 such as the Internet, and 50 designates a computer (PC) of a user which is connectable to the network 40. Note that a DSC 52 is connected to the PC 50 via an interface such as a USB such that the PC 50 can capture an image from the DSC 52.

In addition, a service server 60, which performs the same image processing as the image processing in the portrait image processing apparatus 10, a print server 70 which prints to output a composite image processed in the service server 60, or the like are connected to the network 40.

In the case in which a user uses a compositing processing service of a background image, which is provided by the service server 60, with the cellular phone with camera 30 or the PC 50, the user accesses a web site of the service server 60 to upload an image requesting compositing processing of the background image to the service server 60. In addition, the service server 60 can present a list of background images or the like to the user and cause the user to select a background image.

The service server 60 includes a server computer 62, which has the same function as the portrait image processing apparatus 10 shown in FIG. 1 and a communication function, and a large capacity storage 64, which stores the image uploaded from the user and user information such as a user ID and a mail address. Upon receiving a request for compositing processing for an original image uploaded from the user with a background image, the service server 60 extracts a portrait image from the original image, performs compositing processing of this portrait image and a background image selected in advance, and applies correction processing to a boundary part with low certainty as a contour of a person in a boundary of a person area and a background area. Then, the service server 60 attaches an image, in which the background image is composited, created in this way to an e-mail and distributes the image to the cellular phone with camera 30 and the PC 50 of the user or distributes a mail attached with a URL for image download to the cellular phone with camera 30 and the PC 50 of the user.

In addition, when an order for printing a composite image is received from the user, the service server 60 transfers the composite image to a print server 70. The print server 70 includes a server computer 72 and a print apparatus 74, and prints to output a composite image, in which a background is composited, with the print apparatus 74 on the basis of the composite image received from the service server 60. Note that a photograph print, which is printed and outputted by the print apparatus 74, is delivered to a destination such as a convenience store or a photo processing shop designated by the user or directly delivered to a home of the user.

What is claimed is:

1. A portrait image processing method comprising the steps of:
extracting a portrait image from an original image including a person and a background;
compositing the extracted portrait image and a background image prepared in advance to create a composite image;
detecting a boundary of the person and the background from the original image;
judging whether or not the detected boundary is a true contour of the person for each part of the boundary; and
applying correction processing for concealing a boundary part, which is judged not to be a true contour of the person, to the boundary of the person and the background in the created composite image.

2. The portrait image processing method according to claim 1,
wherein said correction processing is image processing for overwriting another image on the boundary part which is judged not to be the true contour of the person.

3. The portrait image processing method according to claim 1,
wherein said correction processing is image processing for shifting the portrait image such that the boundary part, which is judged not to be the true contour of the person, is outside a frame of the composite image.

4. A portrait image processing apparatus comprising:
a portrait image extracting device which extracts a portrait image from an original image including a person and a background;
a background image recording device which stores a background image to be a background of a portrait image;
an image compositing device which composites the extracted portrait image and the background image read out from said background image recording device to create a composite image;
a boundary detecting device which detects a boundary of the person and the background from the original image;
a judging device which judges whether or not the detected boundary is a true contour of the person for each part of the boundary; and
an image correcting device which applies correction processing for concealing a boundary part, which is judged not to be a true contour of the person, to the boundary of the person and the background in the created composite image.

5. The portrait image processing apparatus according to claim 4,
wherein said image correcting device performs image processing for overwriting another image on the boundary part which is judged not to be the true contour of the person.

6. The portrait image processing apparatus according to claim 4,
wherein said image correcting device performs image processing for shifting the portrait image such that the boundary part, which is judged not to be the true contour of the person, is outside a frame of the composite image.
